(19) United States
(12) Patent Application Publication
(10) Pub. No.: US 2024/0058977 A1
(43) Pub. Date: Feb. 22, 2024

(54) DISPOSABLE SELF-SHARPENING SHAVING DEVICE

(71) Applicants: Jonathan M. Hollis, Ada, MI (US); Christopher M. Lewis, San Antonio, TX (US); Robert B. Whited, Lineville, AL (US)

(72) Inventors: Jonathan M. Hollis, Ada, MI (US); Christopher M. Lewis, San Antonio, TX (US); Robert B. Whited, Lineville, AL (US)

(21) Appl. No.: 18/452,680

(22) Filed: Aug. 21, 2023

Related U.S. Application Data
(60) Provisional application No. 63/399,834, filed on Aug. 22, 2022.

(51) Int. Cl. B26B 21/50; B26B 21/40; B26B 21/22

(52) U.S. Cl. CPC B26B 21/50; B26B 21/4037; B26B 21/225

(57) ABSTRACT

A shaving device including a handle, a sharpening member, and a cartridge. The sharpening member includes an abrasive material. The cartridge couples to the handle. The cartridge also includes an arrangement of double-sided razor blades. Each of the double-sided razor blades includes a pair of shaving edges. The pair of shaving edges are arranged on opposing faces of the cartridge. When the shaving device is used for shaving with a first set of shaving edges of the pair of shaving edges, a second set of shaving edges of the pair of shaving edges contacts the abrasive material and are thereby sharpened.

### CROSS REFERENCE TO RELATED APPLICATION

The present application claims priority of U.S. provisional application Ser. No. 63/399,834, filed Aug. 22, 2022, which is hereby incorporated by reference herein in its entirety.

### FIELD OF THE INVENTION

The present invention is directed to improvements in hand-held shaving devices, and in particular, improvements in disposable self-sharpening razor cartridges.

### BACKGROUND OF THE INVENTION

Conventional disposable razors include handles for holding the razors while shaving is performed. Such disposable razors can include shaving cartridges or heads integrated into a handle, or replaceable shaving cartridges or heads that are insertable onto handles that are fitted for receiving corresponding shaving cartridges or heads. Such replaceable shaving cartridges or heads allow the user to replace a shaving cartridge or head that is no long performing well because its blades are getting dull.

### SUMMARY OF THE INVENTION

Embodiments of the present invention provide a shaving device that includes replaceable razor cartridges as well as a self-sharpening feature. In one embodiment, an exemplary self-sharpening shaving device includes an all-plastic handle and a plastic and metal cartridge with disposable razor blades. The cartridge is insertable onto the handle. The handle includes an arrangement of prongs on a head of the handle that inserts into the cartridge. The head also includes an abrasive material, such as on a flat surface of the head comprising a sharpening member of the head. The sharpening member's abrasive material is positioned to contact shaving edges of dual-sided razor blades contained within the cartridge. The prongs are configured to slide within openings of the razor blades and to contact inner portions of the individual razor blades. The handle and cartridge together form a linear oscillating connection where the action of shaving causes the cartridge to shift up and down against both the spring-like prongs of the handle and the abrasive surface, such that when a user shaves with the shaving device, the cartridge flexes the spring-like prongs and drags the opposite side razor blades of the dual-sided razor blades of the cartridge against the abrasive surface.

According to an aspect of the present invention, an exemplary shaving device includes a handle comprising an attachment end and an abrasive material arranged on a surface of the handle. The shaving device further includes a cartridge comprising an arrangement of double-sided razor blades and configured to attach to the attachment end. Each of the double-sided razor blades includes a pair of opposing shaving edges. The attachment end is configured to flex against the arrangement of double-sided razor blades when the shaving device is used for shaving with a first set of shaving edges of the pair of opposite shaving edges, such that the cartridge moves upwards along the attachment end and a second set of shaving edges of the pair of opposite shaving edges are moved across the abrasive surface and thereby sharpened.

According to another aspect of the present invention, an exemplary shaving device includes a handle, a cartridge, and a wire. The handle includes an attachment end and the cartridge includes an arrangement of double-sided razor blades and attaches to the attachment end. The wire includes a spring end and holds the cartridge in a selected position. Each of the double-sided razor blades includes a pair of shaving edges. The cartridge includes an abrasive material, a knuckle, and a holding frame. The holding frame positions the abrasive material with respect to the cartridge. The knuckle couples the cartridge to the attachment end. The wire couples the cartridge to the knuckle. The spring end of the wire is configured to flex against the cartridge when the shaving device is used for shaving with a first set of shaving edges of the pair of shaving edges, such that the cartridge moves upwards with respect to the sharpening member and a second set of shaving edges of the pair of shaving edges are moved across the abrasive surface and thereby sharpened.

According to yet another aspect of the present invention, an exemplary shaving device includes a handle comprising a head, which includes an attachment end. The shaving device also includes abrasive material arranged on a surface of the U-shaped head, and a cartridge comprising an arrangement of double-sided razor blades that are captured by the attachment end when the cartridge is inserted onto the attachment end. The attachment end includes prongs arranged on opposite sides of the attachment end. Each of the double-sided razor blades includes a pair of opposing shaving edges and openings on either side of an inner member. The openings define their respective inner member. The prongs are configured to reach or extend across their respective double-sided razor blades to reach or extend to their respective inner members. The prongs are configured to flex against their respective double-sided razor blades as the shaving device is used for shaving with a first set of shaving edges. The cartridge moves upwards towards the head along the attachment end. Thus, a second set of shaving edges opposite the first set of shaving edges are moved across the abrasive surface and thereby sharpened.

In another aspect of the present invention, the cartridge includes an upper cartridge bar, a lower cartridge bar, and an end cap. The arrangement of double-sided razor blades is held in position by the upper cartridge bar and the lower cartridge bar, which are positioned above and below the double-sided razor blades, respectively. The end caps are fitted onto either end of the cartridge to hold the arrangement of upper cartridge bar, lower cartridge bar, and double-sided razor blades together.

In a further aspect of the present invention, the lower cartridge bar includes a support post configured to receive and pass through the arrangement of double-sided razor blades. Each of the double-sided razor blades includes an opening configured to receive a portion of support post. The support post is configured to support the arrangement of double-sided razor blades as they rest upon the support post.

In another aspect of the present invention, the cartridge includes a pair of channels. The attachment end also includes a pair of nubs configured to engage with and move up and down within one of the channels of the cartridge. The channels are arranged on either side of an opening through the upper cartridge bar.

In yet another aspect of the present invention, the upper cartridge bar and the lower cartridge bar are plastic.

In a further aspect of the present invention, the arrangement of double-sided razor blades comprises a stack of stamped, stainless steel half-octagon shaped double-sided razor blades that present shaving edges on opposite faces of the cartridge.

In another aspect of the present invention, the handle is an all-plastic handle configured to retain and support the abrasive material.

In yet another aspect of the present invention, each of the double-sided razor blades comprises an inner member with a different width. Each respective inner member is defined by the associated pair of openings. The double-sided razor blades are arranged such that the width of an inner member for a particular double-sided razor blade is wider than the double-sided razor blade above it.

In a further aspect of the present invention, the cartridge includes an opening for receiving and passing the wire through the cartridge. The opening includes a cavity for receiving and retaining the spring end of the wire.

In another aspect of the present invention, the cartridge includes an upper cartridge bar and a lower cartridge bar. The upper and lower cartridge bars hold the arrangement of double-sized razor blades in position between them. The upper and lower cartridge bars are also plastic.

In a further aspect of the present invention, the knuckle includes a rotational channel including a rotational position and a shaving position. The rotational channel guides the wire between the rotational position and the shaving position. When the wire is in the rotational position, the rotational position allows the cartridge to rotate around an axis defined by the wire. When the wire is in the shaving position, the shaving position holds the cartridge in position for shaving.

These and other objects, advantages, purposes and features of the present invention will become apparent upon review of the following specification in conjunction with the drawings.

### BRIEF DESCRIPTION OF THE DRAWINGS

FIG. 1 is a perspective view of a handle and cartridge of a self-sharpening shaving device in accordance with the present invention;

FIG. 1A is a perspective view of the cartridge of FIG. 1 illustrating an exemplary arrangement of razor blades between shaped bar components;

FIG. 1B is a side sectional view of the cartridge of FIG. 1C illustrating the arrangement of the razor blades between shaped bar components;

FIG. 1C is a front sectional view of the cartridge of FIG. 1B further illustrating the arrangement of the razor blades between the shaped bar components;

FIG. 2 is a front perspective view of the handle of FIG. 1;

FIG. 3 is a perspective exploded view of the cartridge of FIG. 1 illustrating an arrangement of razor blades, shaped bar components, and end caps such that the razor blades are stacked between the shaped bar components and held in place with the end caps in accordance with an embodiment of the present invention;

FIG. 4A is a front sectional view of the cartridge and handle head of FIG. 4B illustrating the position of the cartridge inserted onto the handle head and in a resting state in accordance with an aspect of the present invention;

FIG. 4B is a side sectional view of the cartridge and handle head of FIG. 4A illustrating the position of the cartridge inserted onto the handle head and in a resting state in accordance with an aspect of the present invention;

FIG. 5A is a front sectional view of the cartridge and handle head of FIG. 5B illustrating the position of the cartridge inserted onto the handle head when in a shaving state;

FIG. 5B is side sectional view of the cartridge and handle head of FIG. 5A illustrating the position of the cartridge inserted onto the handle head when in a shaving;

FIG. 6 is a perspective exploded view of an alternative cartridge illustrating an arrangement of razor blades, shaped bar components with integrated support post, and end caps such that the razor blades are stacked between the shaped bar components, and held in place with the end caps in accordance with another embodiment of the present invention;

FIG. 7A is a front sectional view of the alternative cartridge and handle head of FIG. 7B illustrating the position of the cartridge inserted onto the handle head and in a resting state, and further illustrating an exemplary integrated support post in accordance with an aspect of the present invention;

FIG. 7B is a side sectional view of the alternative cartridge and handle head of FIG. 7A illustrating the position of the cartridge, and its integrated support post, inserted onto the handle head and in a resting state;

FIG. 8A is a front sectional view of the alternative cartridge and handle head of FIG. 8B illustrating the position of the cartridge inserted onto the handle head when in a shaving state, and further illustrating an exemplary integrated support post;

FIG. 8B is a side sectional view of the alternative cartridge and handle head of FIG. 8A illustrating the position of the cartridge, and its integrated support posted, inserted onto the handle head and in a shaving state; and

FIG. 9A is a side sectional view of the alternative cartridge of FIG. 9B illustrating the arrangement of the razor blades between shaped bar components, and further illustrating an exemplary integrated support post;

FIG. 9B is a front sectional view of the alternative cartridge of FIG. 9B further illustrating the arrangement of the razor blades between the shaped bar components, as well as further illustrating the exemplary integrated support post;

FIG. 10A is a front sectional view of another alternative cartridge of FIG. 10C illustrating an arrangement of razor blades and a supporting wire/rod and spring assembly;

FIG. 10B is another front sectional view of the alternative cartridge of FIG. 10C further illustrating the arrangement of razor blades and the supporting wire/rod and spring assembly while shaving;

FIG. 10C is a side view of an alternative cartridge;

FIG. 10D is a side sectional view of the alternative cartridge of FIG. 12D and further illustrating the arrangement of razor blades and the supporting wire/rod and spring assembly;

FIG. 10E is another side sectional view of the alternative cartridge of FIG. 12D and further illustrating the arrangement of razor blades and the supporting wire/rod and spring assembly while shaving;

FIG. 11A is a perspective view of the cartridge of FIG. 10C illustrating the cartridge in a shaving position;

FIG. 11B is a perspective view of the cartridge of FIG. 11A and illustrating the cartridge rotated downward to a rotation position from the shaving position;

FIG. 11C is a perspective view of the cartridge of FIG. 11A and illustrating the cartridge rotating around an axis while in the shaving position;

FIG. 11D is a perspective view of the cartridge of FIG. 11A and illustrating the cartridge rotated around the axis and ready to rotate back up to the shaving position;

FIG. 11E is a perspective view of the cartridge of FIG. 11A and illustrating the cartridge rotated from the rotation position and back into the shaving position;

FIG. 12A is a front view of the cartridge of FIG. 11A and illustrating the cartridge and a knuckle positioned below the cartridge;

FIGS. 12B and 12C are perspective side views of the knuckle of FIG. 12A;

FIG. 12D is another view of the cartridge and knuckle of FIG. 12A;

FIGS. 12E and 12F are perspective side sectional views of the knuckle of FIG. 12D and illustrating interior views of a channel for the passage and rotation of the wire/bar; and

FIGS. 13A, 13B, and 13C are side perspective views of the knuckle illustrated in FIG. 12B and further illustrating the placement and movement of the wire/bar.

### DESCRIPTION OF THE PREFERRED EMBODIMENTS

The present invention will now be described with reference to the accompanying figures, wherein numbered elements in the following written description correspond to like-numbered elements in the figures. Embodiments of exemplary shaving devices provide for replaceable razor cartridges that include a self-sharpening feature. The shaving device includes an all-plastic handle and a plastic and metal cartridge. A head of the handle includes multiple spring-like prongs facing towards each other on an end that inserts into the cartridge. The head also includes an abrasive material arranged on a flat surface positioned within the handle as a sharpening member. The abrasive material is positioned to contact the shaving edges of one side of the dual-sided razor blades contained within the cartridge. The cartridge includes a stack of half-octagon stamped razor blades that present sharp shaving edges on opposing faces of the cartridge. The spring-like prongs are configured to slide within openings of the stamped razor blades and to contact inner portions of the individual razor blades with outermost portions of the respective spring-like prongs. Each of the inner portions is defined by a pair of openings. The handle and cartridge together form a linear oscillating connection where the action of shaving causes the cartridge to shift up and down against both the spring-like prongs of the handle and the abrasive surface, such that when a user shaves with the shaving device, the cartridge flexes the spring-like prongs and drags the opposite side of the cartridge against the abrasive surface and thereby sharpening the blades that are opposite the blades being used to shave.

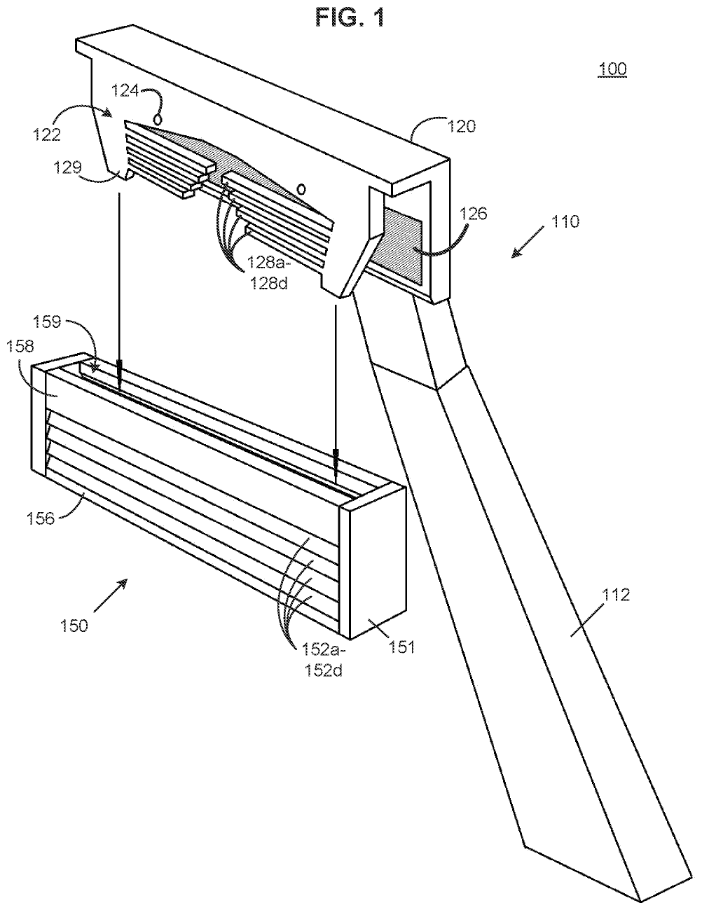

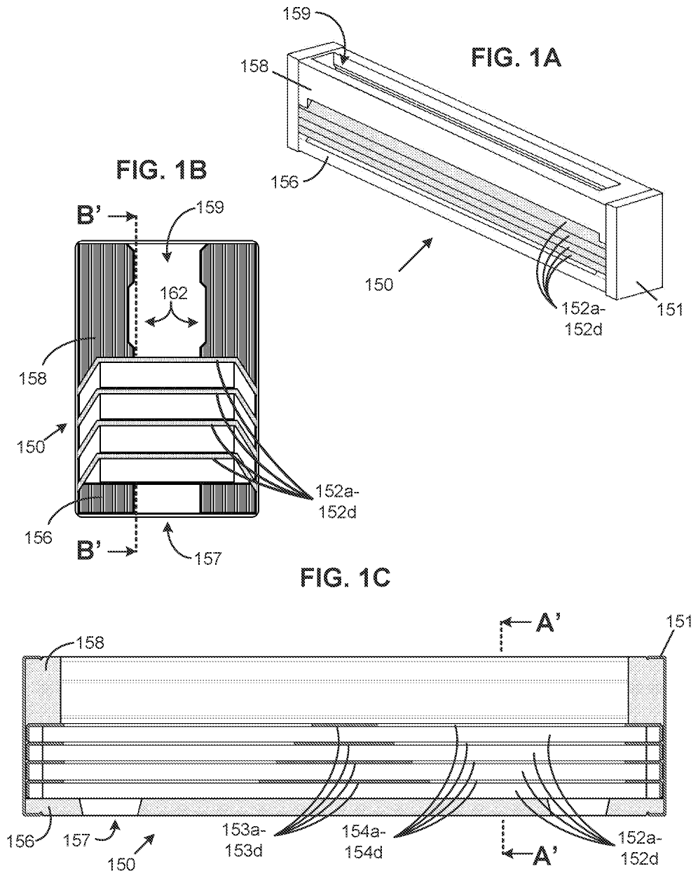

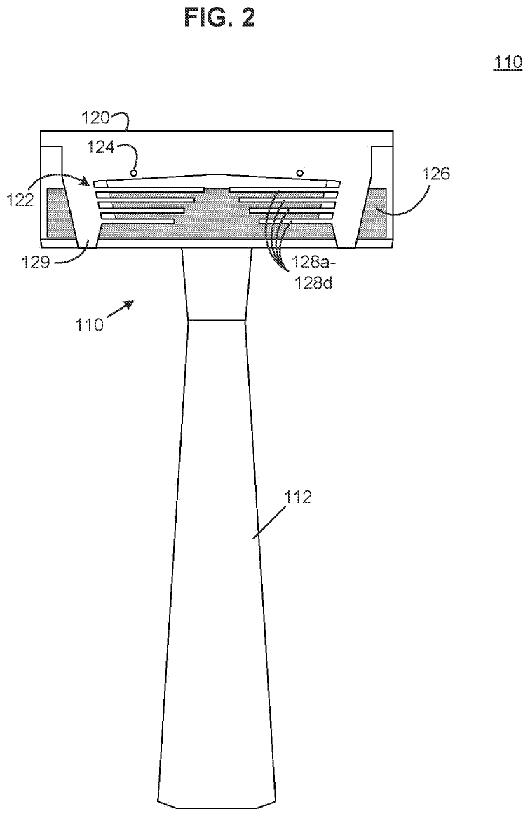

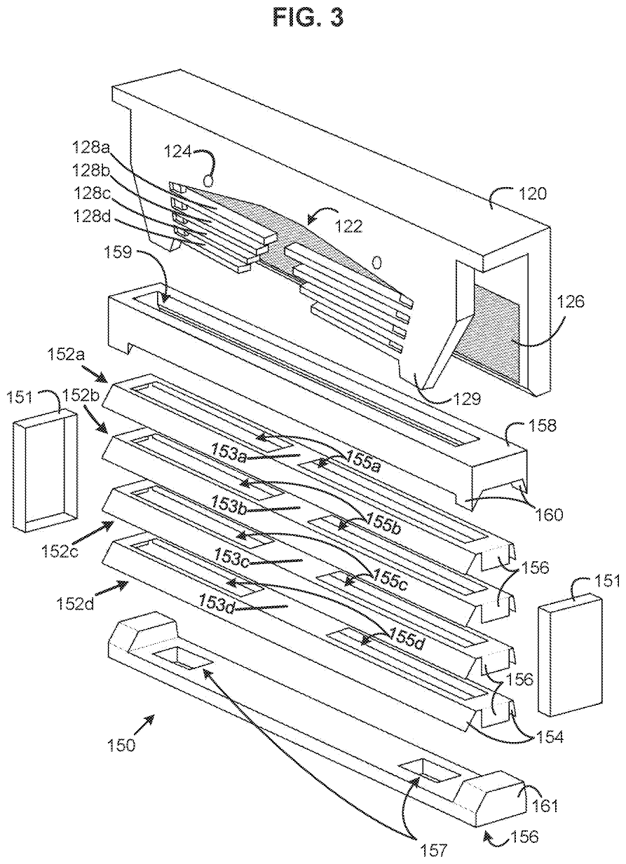

Referring to FIGS. 1 and 2, a shaving device 100 includes a handle 110 and a cartridge 150. The handle 110 includes an elongated gripping member 112 by which a user grips the handle 110. In one embodiment, the gripping member 112 is plastic or other similar material(s) (e.g., titanium, aluminum, stainless steel, and resin). The handle 110 further includes a head 120 that is mechanically coupled to the gripping member 112. Alternatively, the head 120 is an end portion of the handle 110. As illustrated in FIGS. 1 and 2, the head 120 is formed as an upside-down U-shape that ends with an attachment member 122 for coupling a cartridge 150 to the head 120 of the handle 110. The attachment member 122 includes opposing pairs of spring-like prongs 128a-d arranged on opposite sides of the attachment member 122. The attachment member 122 includes a tapered shape that narrows and ends with a pair of tabs 129 that fit into matching openings 157 in a lower cartridge bar 156 of the cartridge 150 (see FIG. 3).

The attachment member 122 also includes a pair of nubs 124, each shaped to fit into channels 162 formed in the opening 159 of the upper cartridge bar 158 (see FIGS. 1, 1B, 4, and 5). As illustrated in FIG. 3, the upper cartridge bar 158 and the lower cartridge bar 156 are arranged above and below, respectively, an arrangement of razor blades 152a-d. End caps 151 are arranged on either side of the cartridge 150 and are configured to hold the upper cartridge bar 158 in position with the lower cartridge bar 156 and thereby sandwiching and holding the arrangement of razor blades 152a-d within the cartridge 150.

The head 120 further includes a sharpening member 126 arranged within the head 120 on the opposite side of the U-shape and opposite the attachment member 122 (see FIG. 1). The sharpening member 126 comprises abrasive material (e.g., stone, ceramic, and diamond plate). The sharpening member 126 is configured such that its abrasive material contacts the shaving edges 154 of the dual-sided razor blades 152a-d contained within the cartridge 150. As discussed herein, the act of a user shaving with the shaving device 100 causes the cartridge 150 to linearly oscillate up and down such that the shaving edges 154 facing the sharpening member 126 are moved up and down against the sharpening member's abrasive material and thereby sharpened.

FIGS. 1A, 1B, and 1C illustrate further depictions of the components of the shaving device 100. FIG. 1A illustrates another perspective view of the cartridge 150 of FIG. 1. FIG. 1B illustrates a sectional side view of the cartridge 150. As illustrated in FIGS. 1B and 1C, FIG. 1B depicts the sectional side view of the cartridge 150 of FIG. 1C at the section cut A′ of FIG. 1C. Meanwhile, FIG. 1C depicts a sectional front view of a cartridge 150 at the section cut B′ of FIG. 1B. Note that the section cut B′ is along a plane parallel with the lengthwise side of the cartridge and along the openings 159, 157 of the upper cartridge bar 158 and the lower cartridge bar 156, respectively. FIG. 1B also illustrates an exemplary arrangement of the upper cartridge bar 158, the lower cartridge bar 156, and the arrangement of razor blades 152a-d sandwiched between the cartridge bars 158, 156. FIG. 1B also illustrates the channels 162 in the upper cartridge bar 158.

FIG. 1C illustrates the arrangement of the lower openings 157 in the lower cartridge bar 158. FIG. 1C also illustrates the inner members 153a-d arranged between the openings in the razor blades 152a-d (see FIG. 3). As discussed herein, and illustrated in FIGS. 3, 4A, and 5A, the spring-like prongs 128a-d extend across the progressively larger openings 155a-d in the razor blades 152a-d to reach the inner members 153a-d. As illustrated in FIGS. 1C and 3, pairs of openings 155a-d are arranged on either side of the respective inner members 153a-d. FIGS. 1C and 3 also illustrate that as each inner member 153a-d has a different width, each defined by the widths of their corresponding openings 155a-d. Edges of the inner members 153a-d of the cartridge 150 are reached by corresponding spring-like prongs 128a-d of the handle's attachment member 120. FIG. 1C also illustrates the end caps 151 (see FIGS. 1, 1A, and 3). As also illustrated in FIGS. 1B, 3, 4B, and 5B, the stack of razor blades 152a-d come with opposing pairs of shaving edges 154 that extend along opposite sides of the razor blades 142a-d.

FIG. 3 illustrates an exemplary exploded view of the cartridge 150 with respect to a perspective view of the head 120. FIG. 3 illustrates a stack of dual-sided razor blades 152a-d, each formed as a stamped half-octagon razor blade 152 that presents a pair of sharp shaving edges 154 on opposite faces of the cartridge 150. Each of the dual-sided razor blades 152a-d includes a flat upper surface into which the pairs of openings 155a-d are stamped. The razor blades 152 are stamped from stainless steel or other similar materials. The corresponding shaving edges 154 and vertical end tabs 156 extend from the sides of the flat upper surface of the razor blades 152 (see FIG. 3). The dual-sided razor blades 152a-d are arranged and stacked one atop the other via their vertical end tabs 156 that extend down to contact the flat upper surface of the razor blade 152 below (see FIG. 1B). When the dual-sided razor blades 152a-d are stacked, their inner portions 153a-d will form a pyramid shape that is complimentary to the arrangement of spring-like prongs 128a-d on the attachment member 122 (see FIG. 1C).

FIG. 3 also illustrates a perspective view of an exemplary upper cartridge bar 158 and lower cartridge bar 156. The upper cartridge bar 158 is formed from plastic with a flat upper surface that defines an opening 159 that extends through the upper cartridge bar 158 and through which the attachment end 122 of the head 120 inserts. The upper cartridge bar 158 is also formed with pairs of tapered or angled legs 160 that extend downward at an angle that matches the angle of the shaving edges 154 of the dual-sided razor blades 152. The lower cartridge bar 156 is also formed from plastic and includes a substantially flat upper surface that includes a pair of rectangular openings 157 on either end. The rectangular openings 157 are positioned to receive the tabs 129 of the attachment end 122. The lower cartridge bar 156 also includes a pair of tampered or angled ends 161, each extending upwards at an angle that matches the angle of the shaving edges 154 of the dual-sided razor blades 152. With the dual-sided razor blades 152a-d stacked atop the lower cartridge bar 156, and the upper cartridge bar 158 placed atop the topmost dual-sided razor blade 152a, a pair of stainless steel end caps 151 are crimped over and around the ends of the upper cartridge bar 158 and the lower cartridge bar 156 and thereby retain and position the set of dual-sided razor blades 152a-d. FIGS. 1B and 1C illustrate the component arrangement in the cartridge 150 and the end caps 151 retaining the arranged components within the cartridge 150. With stainless steel razor blades 152 sandwiched between plastic upper and lower cartridge bars 158, 156, the stainless-steel end caps 151 are crimped into the softer plastic material of the upper and lower cartridge bars 158, 156.

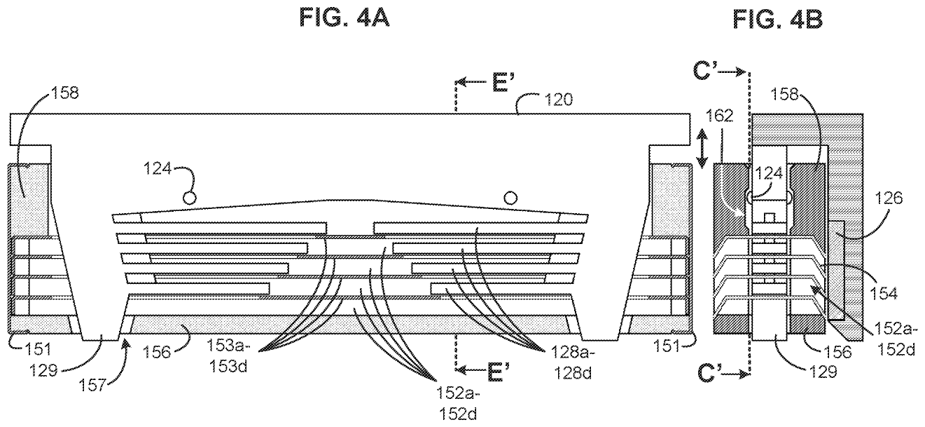

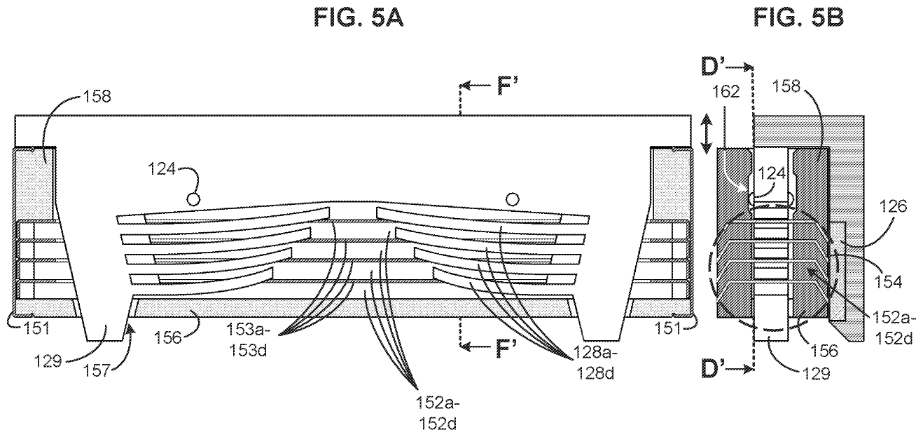

FIGS. 4A and 5A depict sectional front views of a cartridge 150 inserted onto a head 120 of a handle 110 at a section cut C′ of FIG. 4B and a section cut D′ of FIG. 5B, respectively. FIGS. 4B and 5B depict sectional side views of FIGS. 4A and 5B at a section cut E′ of FIG. 4A and section cut F′ of FIG. 5A. Note that FIGS. 4A and 5A illustrate the cartridge 150 moving up and down on the attachment end 122 of the head 110 during the act of shaving.

FIGS. 4A and 4B illustrate the cartridge 150 in a “resting state” with respect to the head 110, while FIGS. 5A and 5B illustrate the cartridge 150 at the end of a “shaving stroke.” In FIGS. 5A and 5B, when at the end of the shaving stroke, the inner side of the dual-sided razor blades 152a-d have been dragged across the abrasive material of the sharpening member 126. As illustrated in FIGS. 4A and 4B, when in the resting state, the spring-like prongs 128a-d are resting against the inner members 152a-d. Note that in the resting state, the nubs 124 are up against a top portion of the channel 162. Meanwhile, when at the end of the shaving stroke, illustrated in FIGS. 5A and 5B, the spring-like prongs 128a-d are flexing against the inner portions 153a-d of the dual-sided razor blades 152a-d. As also illustrated in FIGS. 5A and 5B, the nubs 124 are in a lower portion of the channel 162 and a portion of the upper cartridge bar 158 has contacted the inner surface of the U-shaped head 110. With respect to FIGS. 4B and 5B, it is noted that when the prongs 128a-d are actively flexed in FIG. 5B, that some details visible in FIG. 4B are not visible in FIG. 5B due to the prong flexion.

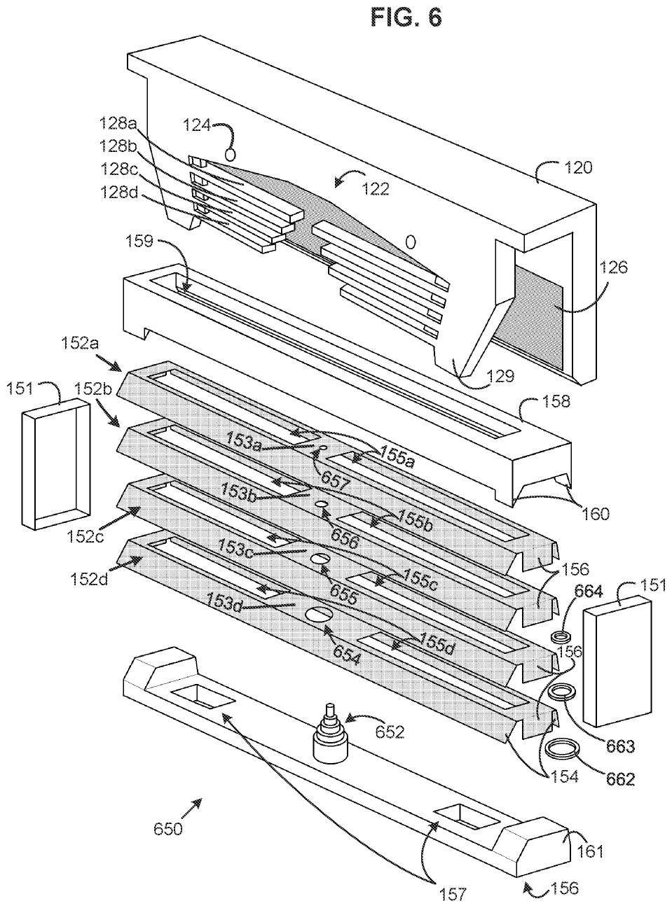

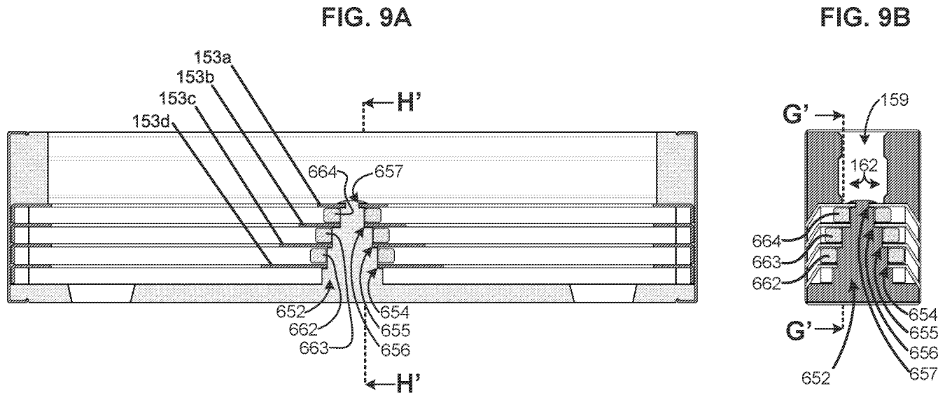

With reference to FIGS. 6-9, an alternative cartridge 650 is illustrated that includes a lower cartridge bar 156 that additionally includes an exemplary support post 652 formed as a series of stacked cylinders of diminishing diameters (that is, a tiered cylindrical post). As the dual-sided razor blades 152a-d are stacked on the lower cartridge bar 156 (via a series of respective circular openings 657, 656, 655, and 654 in the dual-sided razor blades 152a-d), a series of washers or rings (or stamped plastic or rubber material) 662, 663, 664 are arranged on the support post 652. As illustrated in FIGS. 9A and 9B, each washer/ring 662, 663, 664 has an inside diameter that matches a diameter of a particular cylinder tier of the support post 652. The support post 652 and the washers/rings 662, 663, 664 provide additional support for the stacked dual-sided razor blades 152a-d. Because the remaining component parts of the alternative cartridge 650 are substantially the same as in the cartridge 150 already described in detail, the remaining and previously described components of the alternative cartridge 650 will not be described.

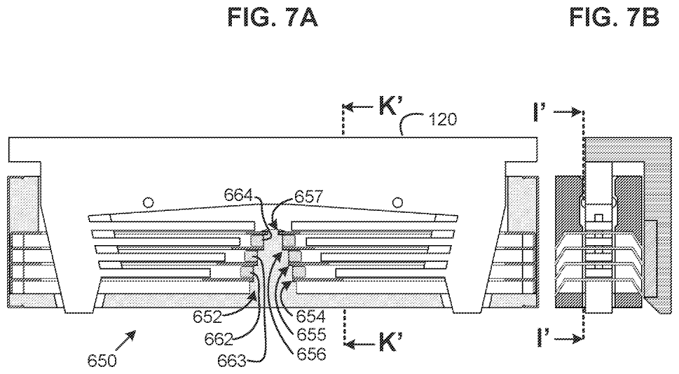

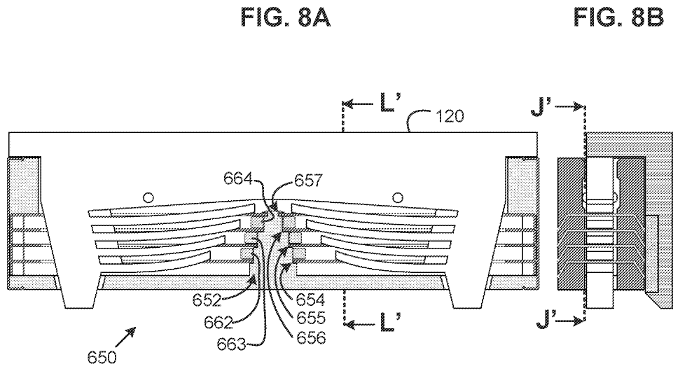

FIGS. 9A and 9B illustrate further depictions of the components of the shaving device 100 with the alternative cartridge 650. As illustrated in FIGS. 9A and 9B, FIG. 9B depicts the sectional side view of the alternative cartridge 650 of FIG. 9A at the section cut H′ of FIG. 9A. Meanwhile, FIG. 9A depicts a sectional front view of the alternative cartridge 650 at the section cut G′ of FIG. 9B. Similar to the sectional cuts illustrated in FIGS. 1B and 1C, note that the section cut G′ is along a plane parallel with the lengthwise side of the cartridge 650 and along the openings 159, 157 of the upper cartridge bar 158 and the lower cartridge bar 156, respectively, such that only sections of the washers/rings 662, 663, 664 are illustrated. Similar to FIGS. 4A, 4B, 5A, and 5B, FIGS. 7A and 8A depict sectional front views of an exemplary alternative cartridge 650 inserted onto a head 120 of a handle 110 at a section cut I′ of FIG. 7B and a section cut J′ of FIG. 8B, respectively. Meanwhile, FIGS. 7B and 8B depict sectional side views of FIGS. 7A and 8A at a section cut K′ of FIG. 7A and a section cut L′ of FIG. 8A. Note that FIGS. 7 and 8, like FIGS. 4 and 5, illustrate the alternative cartridge 650 moving up and down on the attachment end 122 of the head 110 during the act of shaving. FIGS. 7A and 7B illustrate the alternative cartridge 650 in a “resting state” with respect to the head 110, while FIGS. 8A and 8B illustrate the alternative cartridge 650 at the end of a “shaving stroke.”

As illustrated in FIGS. 6, 9A, and 9B, the widths of the respective inner members 153a-d of the dual-sided razor blades 152a-d correspond with the diameters of their respective circular openings 657, 656, 655, and 654. That is, the inner members 153a-d with larger widths, have circular openings 657, 656, 655, and 654 with larger diameters (see FIG. 6). As illustrated in FIGS. 6, 7A, 8A, 9A, and 9B, when the dual-sided razor blades 152a-d are arranged on the lower cartridge bar 156 and the support post 652, a set of washers/rings 662, 663, 664 are each positioned on the tiers of the support post 652 to support a corresponding dual-sided razor blade 152c, 152b, and 152a. As illustrated in FIGS. 9A and 9B, each washer/ring 662, 663, 664 has an inside diameter that matches a diameter of a particular cylinder tier of the support post 652. A respective inner member 153a-c of each of the dual-sided razor blades 152a-c rests upon a corresponding washer/ring 664, 663, and 662 (except for dual-sized razor blade 152d, which rests upon the lowest (and widest) cylinder tier of the support post 652. As illustrated in FIGS. 7A, 8A, 9A, and 9B, the washers/rings 664, 663, 662 are each sandwiched between corresponding dual-sized razor blades 152.

In one exemplary embodiment, the cartridge 150 includes a metal upper cartridge bar 158 and a metal lower cartridge bar 156 for an all-metal cartridge 150. Other exemplary materials include, for example, aluminum, titanium, and stainless steel (specifically 316L stainless).

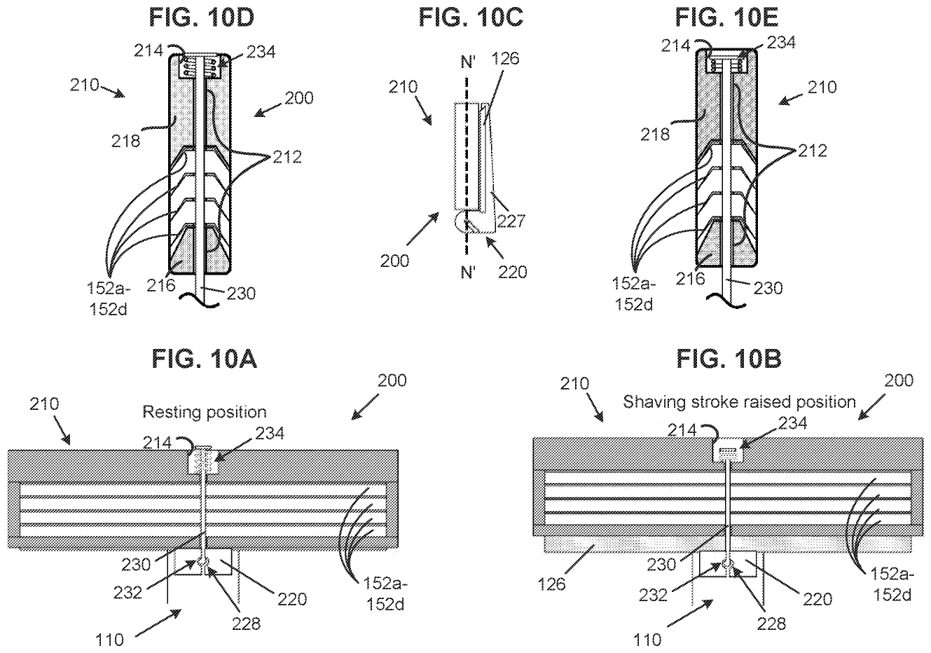

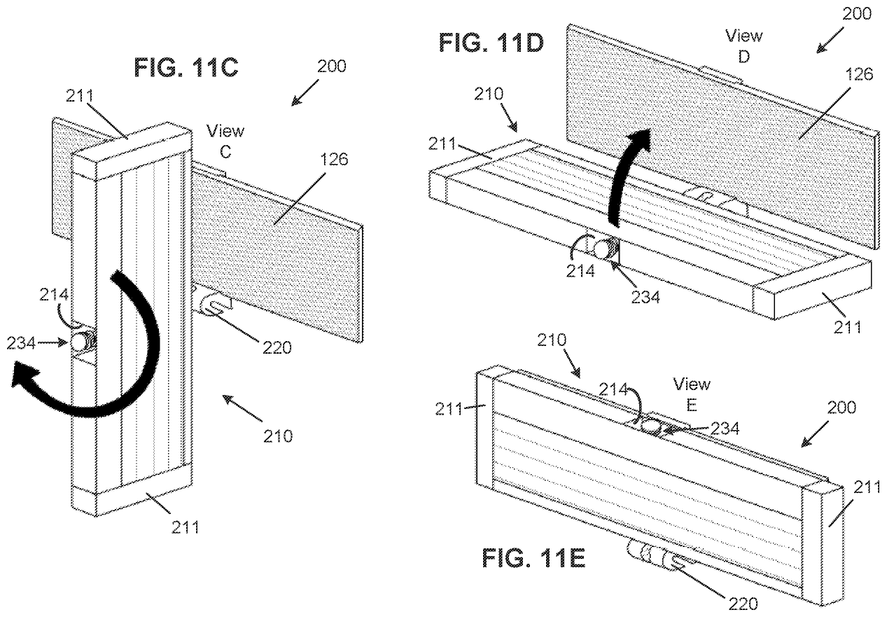

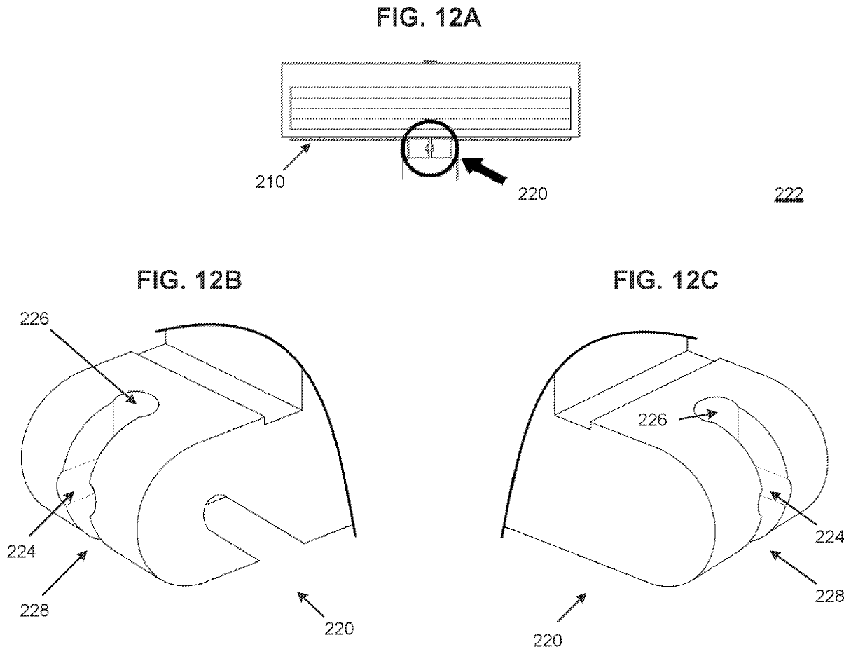

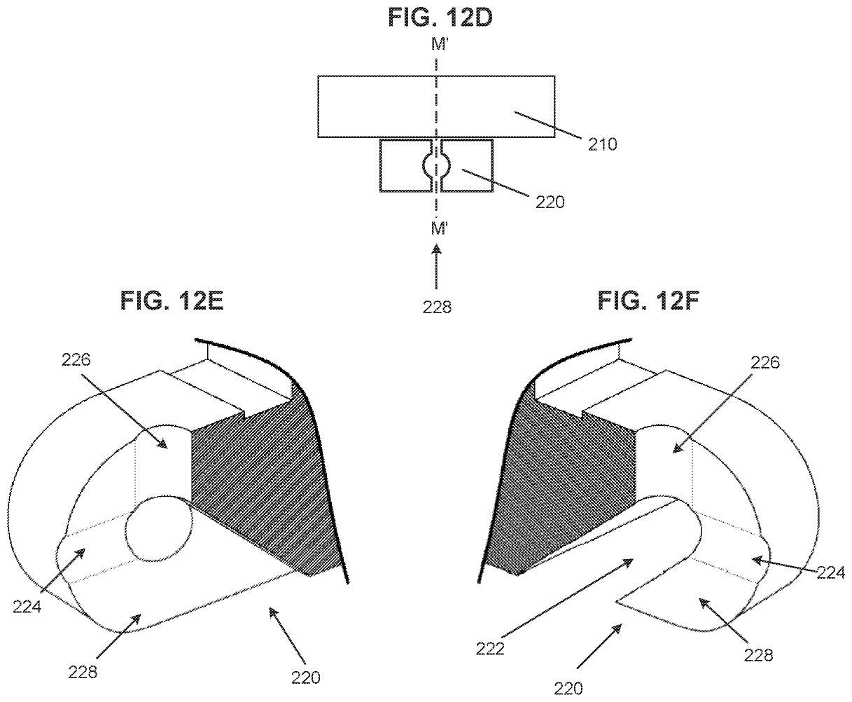

Referring to FIGS. 10-12, a further alternative embodiment of a shaving device comprises a handle 110 and a head 200. Similar to the other embodiments discussed herein, the handle 110 includes an elongated gripping member 112 by which a user grips the handle 110 (see, for example, FIG. 2). In one embodiment, the handle 110 (including the gripping member 112) is plastic or other similar material(s) (e.g., titanium, aluminum, stainless steel, and resin). The head 200 is mechanically coupled to the handle 110. The head 200 comprises a cartridge 210, a knuckle 220 positioned under, and mechanically coupled to the cartridge 210, and a sharpening member 126 mechanically coupled to the knuckle 220 via a fixture frame 227. As illustrated in FIGS. 10A, 10B, and 10C, in coupling to the head 200, the handle 110 is mechanically coupled to the knuckle 220. A wire/bar 230, passing through an opening 212 through the cartridge 210 is captured in the knuckle 220 and thereby mechanically couples the cartridge 210 to the knuckle 220 (and the handle 110). As illustrated in FIGS. 10D and 10E (and discussed herein with respect to FIGS. 12A-12F), one end of the wire/rod 230 includes a bent portion 232 configured to slide into and engage with the knuckle 220, while a spring end 234 on the opposite end of the wire/road 230 is received and retained by a cavity 214 formed in the cartridge 210.

Referring to FIGS. 10D and 10E, which are cross-sectional illustrations of the cartridge 210 at sectional cut M′ of FIG. 12D, the opening 212 runs vertically through the entire vertical length of the cartridge 210 for the passage of the wire/rod 230. The opening 212 is formed/defined by an upper cartridge bar 218 and a lower cartridge bar 216. Note that the upper cartridge bar 218 forms the cavity 214 for receiving the spring end 234 of the wire/rod 230.

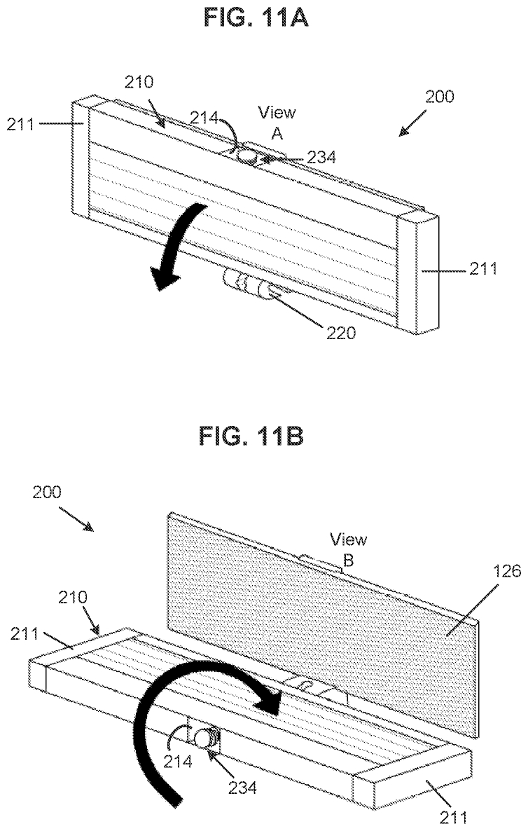

Similar to the other embodiments described herein, the head 200 includes an arrangement of dual-sided razor blades 152a-d that are sandwiched between the upper cartridge bar 218 and the lower cartridge bar 216. Note that the opening 212 extends through the dual-sided razor blades 152a-d. The arrangement of dual-sided razor blades 152a-d and the upper and lower cartridge bars 218, 216, are held in place by a pair of opposing end caps 211 (see FIGS. 11A-11E). Note that each razor blade 152 of the arrangement of dual-sided razor blades 152a-d comprises a pair of shaving edges 154 (see, for example, FIGS. 3 and 6).

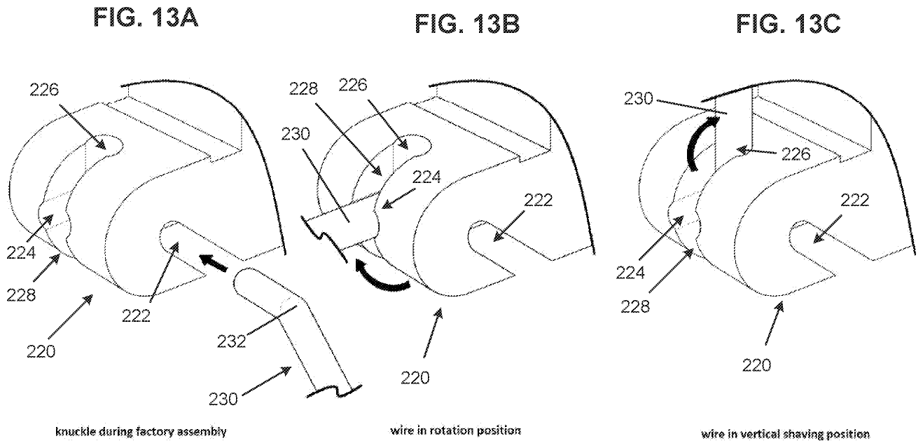

Referring to FIGS. 12A-12F and 13A-13C, the bent portion 232 of the wire/rod 230 is configured to slide into and engage with an entry point 222 in the knuckle 220 (positioned below the cartridge 210). The knuckle 220 has several positions or “indents” (which may also be referred to as “openings”) for receiving the wire/rod 230. When the wire/rod 230 is rotated in the knuckle 220 to a “rotation position” 224, the cartridge 210 is in position to be rotated about the wire/rod 230 (i.e., the wire/rod 230 is an axis about which the cartridge 210 rotates, as illustrated in FIGS. 11B and 11C). When the wire/rod 230 is rotated in the knuckle 220 to a “shaving position” 226 (see FIGS. 11A, 11E; and 13A-13C), the cartridge 210 is in position for shaving and is ready for use.

As illustrated in FIGS. 11A and 11B, starting from an original position, noted as “view A” in FIG. 11A, the wire/rod 230 rotates downward to “view B” illustrated in FIG. 11B. That is, when the cartridge 210 (within which the wire/rod 230 is captured) is manually pulled away from the sharpening member 126 (guided by the wire/rod 230 as it rotates about the knuckle 220), the wire/rod 230 is rotated from the “shaving position” 226 to the “rotation position” 224 (see FIGS. 12B and 12C). With the cartridge 210 (and the wire/rod 230) rotated down to the “rotation position” illustrated in FIG. 11B (i.e., “view B”), the cartridge 210 can then be rotated about an axis defined by the wire/rod 230. As illustrated in FIGS. 11B, 11C, and 11D, the cartridge 210 can be rotated in a clockwise direction (i.e., from “view B” in FIG. 11B, through “view C” in FIG. 11C, and coming to stop at “view D” in FIG. 11D) such that the opposite side of the cartridge 210 has been rotated into place. With the rotation of the cartridge 210 complete, the cartridge 210 and wire/rod 230 can be rotated from the “rotation position” 224 (with respect to the knuckle 220) and back to the shaving position 226. For example, FIGS. 11D and 11E, where the cartridge 210 and wire/rod 230 are rotated from the rotation position 224 (“view D” in FIG. 11D) and back to the shaving position 226 (“view E” in FIG. 11E).

Note that the rotation position 224 and the shaving position 226 are configured to retain the wire/bar 230 (and the cartridge 210) in their respective positions. That is, once the wire/bar 230 and cartridge 210 have been rotated into either position 224, 226, the wire/bar 230 will be retained there until a deliberate physical effort is exerted to remove the wire/bar 230 from its current position 224, 226 (and thereby move the cartridge 210). Thus, as illustrated in FIGS. 12D, 12E, and 12F, the positions 224, 226 within the knuckle 220 are part of a rotational channel 228 within which the wire/bar 230 passes when traveling from one position 224, 226 to the other. Note that FIGS. 12E and 12F illustrate cross-sections of the knuckle 220 at the point of the rotational channel 228 such that the sectional cut M′ transects the rotational channel 228.

Referring to FIGS. 13A, 13B, and 13C, when the wire/rod 130 is inserted into the knuckle 220, the bent end 232 of the wire/rod 230 passes through an entry point 222 which leads to the rotational channel 228. That is, once inserted through the entry point 222, the wire/rod 230 will be captured in the rotation channel 228 and able to rotate between the rotation position 224 and the shaving position 226. FIGS. 13B and 13C provide additional views of the wire/rod 230 rotating through the rotational channel 228 between the “rotational position” 224 (see FIG. 13B) and the “shaving position” 226 (see FIG. 13C).

Similar to the other embodiments discussed herein, the cartridge 210 provides for the sharpening of one set of shaving edges 154 of the dual-sided razor blades 152a-d while a user is shaving with an opposite set of shaving edges 154 of the dual-sided razor blades 152a-d. That is, the action of shaving with the cartridge 210 provides for a motion of the cartridge 210 against a sharpening member 126, such that the opposite set of shaving edges 154 of the dual-sided razor blades 152a-d will be sharpened against the sharpening member 126 while shaving. Thus, when the cartridge 210 is positioned for use (i.e., shaving), the cartridge 210 will be in a “resting position” illustrated in FIG. 10A. Note that FIGS. 10A and 10B illustrate cross-sectional views of the cartridge 210 and knuckle 220 at sectional cut N′ illustrated in FIG. 10C. As the cartridge 210 is used in a shaving stroke, the cartridge 210 will rise against the tension of the spring end 234 (i.e., the cartridge's rise against the spring end 234 puts tension on the spring end 234). At the completion of the shaving stroke, the tension against the spring end 234 is released and the cartridge 210, responding to the releasing tension of the spring end 234 will return to the resting position of FIG. 10A.

Similar to other embodiments, the head 200 includes a sharpening member 126 arranged within the head 200 and coupled to the knuckle 220 via the frame member 227. The sharpening member 126 comprises abrasive material (e.g., stone, ceramic, and diamond plate). The sharpening member 126 is configured such that its abrasive material contacts the shaving edges 154 of the dual-sided razor blades 152a-d contained with the cartridge 210.

As illustrated in FIGS. 10A and 10B, when the head 200 and handle 112 are in the “shaving position,” the cartridge 210 is positioned in front of the sharpening member 126, such that while one side of the dual-sided razor blades 152a-d is positioned outwardly for shaving, the opposite side of the dual-sided razor blades 152a-d is positioned against the sharpening member 126. As discussed herein, the act of a user shaving with the shaving device causes the cartridge 210 to linearly oscillate up and down, such that the shaving edges 154 facing the sharpening member 126 are moved up and down against the sharpening member's abrasive material and thereby sharpened.

Thus, an exemplary shaving device 100 includes replaceable razor blade cartridges as well as providing a self-sharpening feature. Embodiments of the shaving device include an all-plastic handle and a plastic and metal cartridge. A head of the handle includes multiple spring-like prongs facing towards each other on an end that inserts into the cartridge. The head also includes an abrasive material arranged on a flat surface positioned within the handle. The abrasive material is positioned to contact the shaving edges of one side of the dual-sided razor blades contained within the cartridge. The cartridge includes a stack of razor blades that present sharp saving edges on opposing faces of the cartridge. The spring-like prongs are configured to slide within openings of the stamped razor blades and to contact inner portions of the individual razor blades with outermost portions of the respective spring-like prongs. The handle and cartridge together form an linear oscillating connection where the action of shaving causes the cartridge to shift up and down against both the spring-like prongs of the handle and the abrasive surface, such that when a user shaves with the shaving device, the cartridge flexes the spring-like prongs and drags the shaving edges of the opposite side of the cartridge against the abrasive surface and thereby sharpens the shaving edges that are opposite the shaving edges being used to shave.

Changes and modifications in the specifically described embodiments can be carried out without departing from the principles of the present invention which is intended to be limited only by the scope of the appended claims, as interpreted according to the principles of patent law including the doctrine of equivalents.

1. A shaving device comprising:
a handle comprising an attachment end;
an abrasive material arranged on a surface of the handle;
a cartridge comprising an arrangement of double-sided razor blades and configured to attach to the attachment end;
wherein each of the double-sided razor blades comprises a pair of shaving edges, wherein the pair of shaving edges are arranged on opposing faces of the cartridge;
wherein the attachment end is configured to flex against the arrangement of double-sided razor blades when the shaving device is used for shaving with a first set of shaving edges of the pair of shaving edges, such that the cartridge moves upwards along the attachment end and a second set of shaving edges of the pair of shaving edges are moved across the abrasive surface and thereby sharpened.

2. The shaving device of claim 1, wherein the attachment end comprises an arrangement of prongs arranged on opposite sides of the attachment end, and wherein the arrangement of prongs is configured to contact and flex against respective double-sided razor blades as the shaving device is used for shaving, such that the cartridge moves upwards along the attachment end towards a head of the handle.

3. The shaving device of claim 1, wherein the cartridge comprises a pair of channels, and wherein the attachment end comprises a pair of nubs configured to engage with and move up and down within the channels of the cartridge.

4. The shaving device of claim 3, wherein the cartridge comprises an upper cartridge bar, a lower cartridge bar, and an end cap, wherein the arrangement of double-sided razor blades are held in position by the upper cartridge bar and the lower cartridge bar, which are positioned above and below the double-sided razor blades, respectively, wherein the end caps are fitted onto either end of the cartridge to hold the arrangement of upper cartridge bar, lower cartridge bar, and double-sided razor blades together, and wherein the channels are arranged on the walls of either side of an elongated opening through the upper cartridge bar.

5. The shaving device of claim 4, wherein the lower cartridge bar comprises a support post configured to receive and pass through the arrangement of double-sided razor blades, wherein each of the double-sided razor blades comprises a respective opening configured to receive a cylinder tier of the support post, and wherein the support post is configured to support the arrangement of double-sided razor blades as they rest upon the cylinder tiers of the support post.

6. The shaving device of claim 4, wherein the upper cartridge bar and the lower cartridge bar are plastic, and wherein the handle is an all-plastic handle configured to retain and support the abrasive material.

7. A shaving device comprising:
a handle;
a cartridge comprising an arrangement of double-sided razor blades and configured to attach to the handle; and
a wire comprising a spring end and configured to hold the cartridge in a selected position with respect to the handle;
wherein each of the double-sided razor blades comprises a pair of shaving edges, each arranged on opposing faces of the cartridge;
wherein the cartridge comprises an abrasive material, a knuckle, and a holding frame, and wherein the holding frame is configured to position the abrasive material with respect to the cartridge;
wherein the knuckle is configured to couple the cartridge to the handle;
wherein the wire is configured to couple the cartridge to the knuckle; and
wherein the spring end of the wire is configured to flex against a movement of the cartridge when the shaving device is used for shaving with a first set of shaving edges of the pair of shaving edges, such that the cartridge moves upwards with respect to the sharpening member and a second set of shaving edges of the pair of shaving edges are moved across the abrasive material and thereby sharpened.

8. The shaving device of claim 7, wherein the cartridge comprises an opening configured to receive and pass the wire through the cartridge, and wherein the opening comprises a cavity configured to receive and retain the spring end of the wire.

9. The shaving device of claim 7, wherein the cartridge comprises an upper cartridge bar and a lower cartridge bar, wherein the upper and lower cartridge bars are configured to hold the arrangement of double-sided razor blades in position between them, and wherein the upper cartridge bar and the lower cartridge bar are plastic.

10. The shaving device of claim 7, wherein the knuckle comprises a rotational channel comprising a rotational position and a shaving position, wherein the rotation channel is configured to guide the wire between the rotational position and the shaving position, and wherein the rotational position is configured to allow the cartridge is rotate around an axis defined by the wire, and wherein the shaving position is configured to hold the cartridge in position for shaving.

11. A shaving device comprising:
a handle;
a sharpening member comprising an abrasive material; and
a cartridge configured to couple to the handle, wherein the cartridge comprises an arrangement of double-sided razor blades;
wherein each of the double-sided razor blades comprises a pair of shaving edges, wherein the pair of shaving edges are arranged on opposing faces of the cartridge;
wherein when the shaving device is used for shaving with a first set of shaving edges of the pair of shaving edges, a second set of shaving edges of the pair of shaving edges contacts the abrasive material and are thereby sharpened.

12. The shaving device of claim 11, wherein the sharpening member is arranged on a surface of the handle, and wherein the handle comprises an attachment end, wherein the cartridge is configured to attach to the attachment end, and wherein the attachment end is configured to flex against the arrangement of double-sided razor blades when the shaving device is used for shaving, such that the cartridge moves upwards along the attachment end and the second set of shaving edges of the pair of shaving edges are moved across the abrasive surface and thereby sharpened.

13. The shaving device of claim 12, wherein the attachment end comprises an arrangement of prongs arranged on opposite sides of the attachment end, and wherein the arrangement of prongs is configured to contact and flex against respective double-sided razor blades as the shaving device is used for shaving, such that the cartridge moves upwards along the attachment end towards a head of the handle.

14. The shaving device of claim 12, wherein the cartridge comprises a pair of channels, and wherein the attachment end comprises a pair of nubs configured to engage with and move up and down within the channels of the cartridge.

15. The shaving device of claim 14, wherein the cartridge comprises an upper cartridge bar, a lower cartridge bar, and an end cap, wherein the arrangement of double-sided razor blades are held in position by the upper cartridge bar and the lower cartridge bar, which are positioned above and below the double-sided razor blades, respectively, wherein the end caps are fitted onto either end of the cartridge to hold the arrangement of upper cartridge bar, lower cartridge bar, and double-sided razor blades together, and wherein the channels are arranged on the walls of either side of an elongated opening through the upper cartridge bar.

16. The shaving device of claim 15, wherein the lower cartridge bar comprises a support post configured to receive and pass through the arrangement of double-sided razor blades, wherein each of the double-sided razor blades comprises a respective opening configured to receive a cylinder tier of the support post, and wherein the support post is configured to support the arrangement of double-sided razor blades as they rest upon the cylinder tiers of the support post.

17. The shaving device of claim 11 further comprising a wire comprising a spring end and configured to hold the cartridge in a selected position with respect to the handle, wherein the cartridge further comprises the sharpening member, a knuckle, and a holding frame, and wherein the holding frame is configured to position the sharpening member with respect to the cartridge, wherein the knuckle is configured to couple the cartridge to the handle, wherein the wire is configured to couple the cartridge to the knuckle, and wherein the spring end of the wire is configured to flex against a movement of the cartridge when the shaving device is used for shaving, such that the cartridge moves upwards with respect to the sharpening member and the opposite shaving edges of the pair of shaving edges are moved across the abrasive material and thereby sharpened.

18. The shaving device of claim 17, wherein the cartridge comprises an opening configured to receive and pass the wire through the cartridge, and wherein the opening comprises a cavity configured to receive and retain the spring end of the wire.

19. The shaving device of claim 18, wherein the knuckle comprises a rotational channel comprising a rotational position and a shaving position, wherein the rotation channel is configured to guide the wire between the rotational position and the shaving position, and wherein the rotational position is configured to allow the cartridge to rotate around an axis defined by the wire when the wire is held in the rotational position, and wherein the shaving position is configured to hold the cartridge in position for shaving when the wire is held in the shaving position.

20. The shaving device of claim 11, wherein the arrangement of double-sided razor blades comprises a stack of stamped, stainless-steel half-octagon shaped double-sided razor blades that present shaving edges on opposite faces of the cartridge.
